(19) United States
(12) Patent Application Publication
(10) Pub. No.: US 2015/0227632 A1
(43) Pub. Date: Aug. 13, 2015

(54) OCCUPATIONAL SPECIALTY AND CLASSIFICATION CODE DECODING AND MATCHING METHOD AND SYSTEM

(71) Applicant: MILITARY JOB NETWORKS, INC., Washington, DC (US)

(72) Inventors: Jonathon Lunardi, Silver Spring, MD (US); Pamela M. Ferris, Sioux Falls, SD (US); Patrick Wilson, Oklahoma City, OK (US)

(21) Appl. No.: 14/619,895

(22) Filed: Feb. 11, 2015

Related U.S. Application Data
(60) Provisional application No. 61/938,431, filed on Feb. 11, 2014.

(51) Int. Cl. G06F 17/30; G06F 3/0484

(52) U.S. Cl. CPC G06F 17/30867; G06F 17/30598; G06F 3/04842

(57) ABSTRACT

A system and method utilizes a heuristic and databases to decode codes of profiles into plain language and to derive inferences from characteristics of the profiles. The system and method may then automatically match the combination of plain language and/or inferences to specific instances of a plurality of content (e.g., job postings and work opportunities, continuing education classes and educational training, other profiles, entrepreneurial prospects, and geographic resources) and provide the matched instances via a user interface.

### CROSS-REFERENCE TO RELATED APPLICATION

This application claims the benefit of provisional patent application Ser. No. 61/938,431, filed Feb. 11, 2014.

### BACKGROUND

Job search websites generally enable introductions of job candidates and employers through user interfaces and search engines particular to the job search websites, along with offering tools for building résumés. However, these job search websites purely execute ‘data in, data out’ processes and do not link users together and/or with relevant, specific content. For example, a job search website may accept, as data inputs, Military Occupation Specialty (“MOS”) codes from Veterans and return, as data outputs, a set of suggested civilian skills for the Veteran's resume.

Yet, outside of executing ‘data in, data out’ processes, these job search websites fail to offer intelligent matching services and communities of candidates with shared work/job experience. Inefficiencies arising out of existing tools may result in increased bandwidth and/or computation footprint. These challenges, particular to the Internet and the field of job search websites, make it difficult to effectively retain users and visitors. To overcome such a problem specifically arising in the realm of computer networks, a solution necessarily rooted in computer technology is needed.

Thus, it would be desirable to provide a system and method for creating online groups/spaces to network users together based on shared past job experiences, education, and future career interests, that translates or decodes specific inputted codes (e.g., employment related codes) of profiles into plain language to support intelligent group creation and matching services between job candidates, employers, education programs, and third parties, and other useful content. Moreover, there is a need to accomplish the above with a minimal computational footprint while using a minimum of bandwidth.

### SUMMARY OF THE INVENTION

Various aspects of the present disclosure provide for decoding particular codes indicative of user attributes, automatically and intelligently creating groups, and automatically matching services between job candidates, employers, education programs, and third parties.

In one exemplary aspect of the present disclosure, a method of electronically connecting job searches with third parties comprises: automatically at a server of a job search provider, in response to a user input at a web browser of a user, decoding a code of a member profile to generate a plurality of profile characteristics via a heuristic; automatically retrieving from a data store coupled to the server a plurality of previously-established profiles; automatically matching the member profile to one or more of the plurality of previously-established profiles to generate respective connections; and automatically generating and presenting at least one user interface to the user, the at least one user interface indicative of a result of the matching.

In another exemplary aspect of the present disclosure, a system for electronically connecting job searchers with third parties comprises: a data store at a job search provider; a server coupled to the data store and programmed to: automatically, in response to a user input at a web browser of a user, decode a code of a member profile to generate a plurality of profile characteristics via a heuristic; automatically retrieve from the data store a plurality of previously-established profiles; automatically match the member profile to one or more of the plurality of previously-established profiles to generate respective connections; and automatically generate and present at least one user interface to the user, the at least one user interface indicative of a result of the matching.

In the above exemplary aspects of the present disclosure, the code may include a plurality of data bits representative of user traits selected from the group comprising previous employment, education, military starting rank, military ending rank, combat experience, deployment history, personal interests, volunteer experience, marital status, location, and age. For example, the code may be a Military Occupational Specialty and Classification Code (MOSCC).

In so doing, various aspects of the present disclosure provide for improvements in the underlying technological field of electronic job searching, as well as related technological fields. Moreover, various aspects of the present disclosure provide for increased efficiencies in the use of computer resources such as processor time and memory, as well as Internet resources such as bandwidth and server overhead.

The present disclosure can be embodied in various forms, including business processes, application-specific computer implemented methods, computer program products, computer systems and networks, user interfaces, application programming interfaces, and the like. The foregoing summary is intended merely to provide a general overview of various aspects of the present disclosure, and is not intended to limit the scope of this application in any way.

### BRIEF DESCRIPTION OF THE DRAWINGS

These and other more detailed and specific features of the described are more fully disclosed in the following specification, reference being had to the accompanying drawings, in which:

FIG. 1 illustrates a scheme in which devices operate to provide intelligent matching services;

FIG. 2 illustrates a schematic of a device which operates within the system to provide intelligent group creation and matching services;

FIG. 3 illustrates a process flow performed by the decoding, matching, and group creation application; and

FIGS. 4-15 illustrate exemplary interfaces generated by the decoding, matching, and group creation application.

### DETAILED DESCRIPTION OF THE INVENTION

A system and method provides for decoding codes (e.g., employment related codes) of profiles into plain language to support intelligent matching services of job candidates, employers, and third parties, e.g., to create online groups for career conversations, mentoring interactions, and entrepreneurial discussions.

For instance, the system and method may be an occupational specialty and classification code decoding and matching system (“System”) that, in general, utilizes a heuristic and databases to decode codes (e.g., employment related codes) of profiles into plain language and to derive inferences from characteristics of the profiles. The System then automatically matches the combination of plain language and/or inferences to specific instances of a plurality of content (e.g., job postings and work opportunities, continuing education classes and educational training, other profiles, entrepreneurial prospects, and geographic resources). The System provides the matched instances via a dynamic user interface that is customized for maximum context and relevance and enables online group creation and joining based on assigned codes and common language keywords. Thus, the System creates online groups or communities of users with the same or similar occupational specialty codes or other characteristics/features and then matches relevant, dynamic content to each group for easy, simple access that is personalized to each user in a scalable system.

For example, the System may include a plurality of member profiles, each of which is respective to a user who has a connection with the military (e.g., Veterans and U.S. Active Military, and family members thereof). While the particular examples provided below are given in the context of a user who has a direct personal connection with the military (that is, a user who is currently or has previously been a member of the military), the present disclosure applies similarly to a user who has an less direct connection with the military (that is, a user who is the spouse or dependent of a person who is currently or has previously been a member of the military).

A profile is one type of an electronic record, as described below, that digitally represents a user through codes, characteristics, preferences, and configurations. Each member profile further includes at least one employment related code, such as a military occupational specialty code and/or classification (collectively referenced to as military occupational specialty and classification codes or “MOSCCs”), and/or at least one profile characteristics (“Characteristic”), such as military competency, evaluations, and verified skills.

A MOSCC(s) is alphanumeric code(s) or identifier(s) that is particular to a job within a military branch, such as the United States Army, United States Marines, United States Air Force (which utilizes Air Force Specialty Codes), the United States Navy (which utilizes ratings and designators along with the Navy Enlisted Classification system), and the United States Coast Guard. MOSCC(s) may also be an abbreviation, such as when a branch utilizes a nine character sequence to designate a job, a MOSCC may be a three character string pointing to the associated nine character sequence. MOSCC(s) may also include duty military occupational specialty codes, which are utilized to identify a primary job function when an individual obtains multiple job specialties at the same time. Examples of MOSCC(s) may include 47GX, which is a dentist in the U.S. Air Force; 47KX, which is a pediatric dentist in the U.S. Air Force; 63A, which is a general dentist in the U.S. Air Force; 63B, which is a comprehensive dentist in the Department of the Army; 63K, which is a pediatric dentist in the Department of the Army; 0525, which is a comprehensive dentist in the U.S. Marine Corps; 68E, which is a dental specialist in the Department of the U.S. Army; 92F, which is a petroleum supply specialist in the Department of the Army; 95L, which is a petroleum laboratory specialist in the Department of the Army; 63P, which is an oral pathologist in the department of the U.S. Army; 0402, which is a logistics officer in the U.S. Marine Corps; 1319, which is a bulk fuel specialist in the U.S. Marine Corps.

A Characteristic is a descriptor of a quality, attribute, or trait particular to the user of the respective profile and, thus, may be considered a category for presenting a particular value. Characteristics may also be the descriptors that round-out, enhance, and/or complement the MOSCC(s) of a member profile. Examples of Characteristics may include rank, positions, starting rank, ending rank, combat experience, deployment destinations, etc. Other examples of Characteristics may include personal interests and/or non-work activities, as in golfing, hunting, painting, fishing, cooking, theology, political affiliation, favorite books/movies/music, volunteering, marital status, location, age, etc.

The System, for each member profile, automatically decodes the MOSCC(s) into plain language or civilian dialect via tables stored in databases (e.g., a lookup table) and derives inferences from the Characteristics via a heuristic. Utilizing the civilian dialect, the inferences, or combination thereof, the System automatically matches each member profile to instances of a plurality of content, e.g., such that each member profile is intelligently matched to job candidates, employers, and third parties. Thus, at any point, a user may access their member profile via a user interface of the system to view their particular instances of the plurality of content.

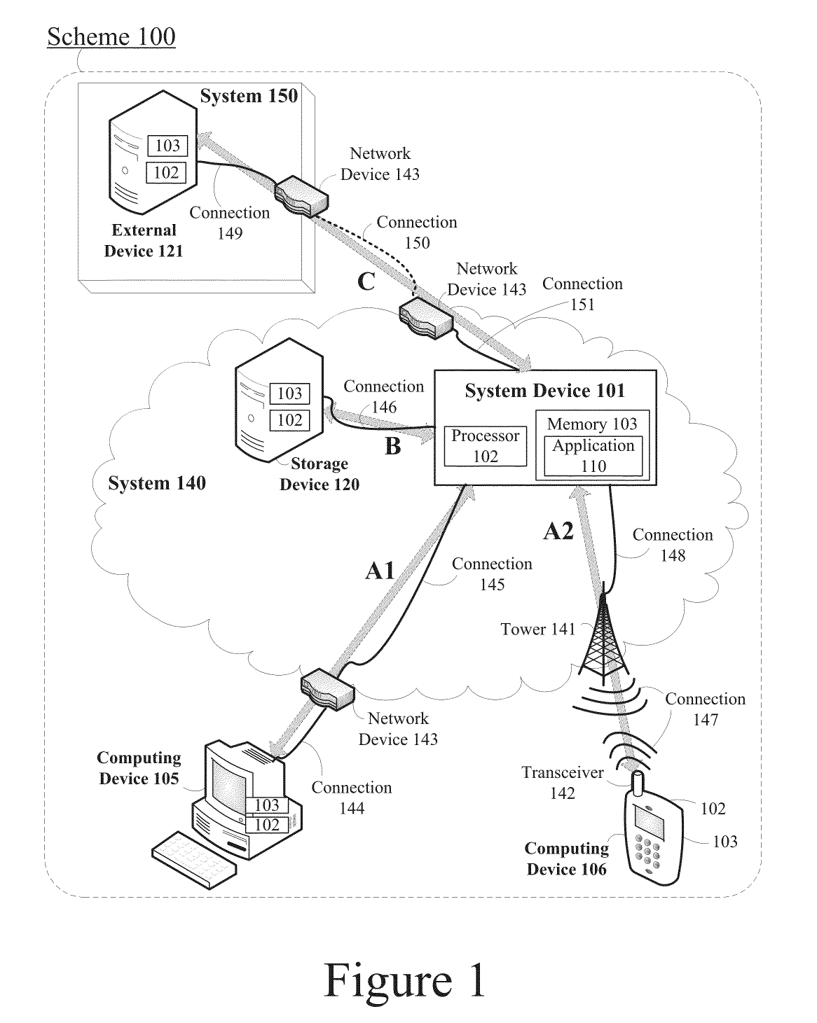

FIG. 1 illustrates a scheme 100 in which devices 101, 105, 106, 120, 121 supported by systems 140A-B operate to intelligent matching services. For instance, FIG. 1 illustrates a system device 101 that communicates via communications A1, A2 with a computing device 105, a computing device 106; that communicates via communication B with a storage device 120 within a system 140A; and that communicates via communication C with an external device 121 of an external system 140B to decode codes (e.g., employment related codes) of profiles into plain language to support intelligent matching services of job candidates, employers, and third parties.

For example, in response to receiving an indication that identifies a member profile from a computing device 105, the system device 101 may utilize a decoding, matching, and group creation application 110 (application 110) stored on a memory 103 to access the identified member profile and other records related to the identified member profile from the storage device 120 and the external device 121 (e.g., via communications B, C). The application 110 may in turn extract codes from the identified member profile, access tables stored in the storage device 120 and the external device 121 based on the extracted codes, decode the codes based on the accessed tables into plain language, and associate the identified member profile with the plain language. The application 110 may also extract profile characteristics from the identified member profile, utilize a heuristic to make inferences form the extracted profile characteristics, and associate the identified member profile with the inferences. Utilizing the plain language, the inferences, or combination thereof, the application 110 automatically matches the identified member profile to instances of a plurality of content. Next, the application 110 may generate an interface that presents the identified member profile, where the interface may illustrate the plain language translation, the inferences, the matched instances, etc. The interface is communicated via communication A1 to the computing device 105 by the system device 101 so that a complete, unrestricted, and comprehensive presentation of the identified member profiles, including intelligent content matches, may be displayed by the computing device 105 to the user.

The items of the scheme 100 will now be further described with reference to FIG. 1, as FIG. 1 illustrates exemplary infrastructure components that support the communication operations (e.g., communications A1-2, B, C) between the devices 101, 105, 106, 120, 121 and systems 140A-B. The exemplary infrastructure components may include a tower 141, a transceiver 142, a network device 143, and connections 144-151. FIG. 1 also includes alternative representations for the computing devices 105, 106, to illustrate different configurations of the scheme 100, which are further described below.

The scheme 100, devices 101, 105, 106, 120, 121, and systems 140A-B may be any computing system and/or device that includes a processor and a memory (e.g. 102 and 103, respectively). Computing systems and/or devices generally include computer-executable instructions, where the instructions may be executable by one or more computing devices such as those listed below. Computer-executable instructions may be compiled or interpreted from computer programs created using a variety of programming languages and/or technologies, including, without limitation, and either alone or in combination, Java™, C, C++, Visual Basic, Java Script, Perl, etc. The scheme 100 and items therein (e.g., the devices 101, 105, 106, 120, 121, and the systems 140A-B) may take many different forms and include multiple and/or alternate components and facilities, as illustrated in the Figures further described below. While exemplary systems, devices, modules, and sub-modules are shown in the Figures, the exemplary components illustrated in the Figures are not intended to be limiting. Indeed, additional or alternative components and/or implementations may be used, and thus the above communication operation examples should not be construed as limiting.

In general, computing systems and/or devices (e.g., the scheme 100, the devices 101, 105, 106, 120, 121, and the systems 140A-B) may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing systems and/or devices include, without limitation, cell phones, smart-phones (e.g., the computing device 106), super-phones, tablet computers, next generation portable devices, mobile printers, handheld computers, secure voice communication equipment, networking hardware, or some other computing system and/or device. Alternatively, computing systems and/or devices may also be a computer workstation, a server (e.g., system device 101), a desktop (e.g., the computing device 105), a notebook, a database (e.g., devices 121, 121), or a laptop.

Further, the processor or the microprocessor (e.g., processors 102) of computing systems and/or devices receives instructions from the memory (e.g., memories 103) and executes these instructions, thereby performing one or more processes, including one or more of the processes described herein (e.g., the accessing, processing, translating, decoding, associating, generating, and presenting). Such instructions and other data may be stored and transmitted using a variety of computer-readable mediums (e.g., memory 103).

A processor 102 may include processes comprised from any hardware, software, or combination of hardware or software that carries out instructions of a computer programs by performing logical and arithmetical calculations, such as adding or subtracting two or more numbers, comparing numbers, or jumping to a different part of the instructions. For example, the processor 102 may be any one of, but not limited to single, dual, triple, or quad core processors (on one single chip), graphics processing units, visual processing units, and virtual processors.

A memory 103 may be, in general, any computer-readable medium (also referred to as a processor-readable medium) that may include any non-transitory (e.g., tangible) medium that participates in providing data (e.g., instructions) that may be read by a computer (e.g., by processors 102 of the devices 101, 105, 106, 120, 121). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including radio waves, metal wire, fiber optics, and the like, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, the elements of the devices 101, 105, 106, 120, 121 may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the operations described herein.

The system device 101 and computing devices 105, 106 may generally be any electronic hardware that includes a processor 102 and a memory 103 and is capable of receiving and processing inputs (e.g., user entered data that provides indications as described below) and sending/receiving electronic data transfers (e.g., communications A1-2, B, C) to and from the systems 140A-B that include those inputs.

The system device 101 and computing devices 105, 106 may further, include a display, support interfaces, and/or communicate within the scheme 100. A display is an output device for presentation of information in visual or tactile form, such as interfaces or web portals. Examples of display may include, without limitation, cathode ray tube display, light-emitting diode display, electroluminescent display, electronic paper, plasma display panel, liquid crystal display, high-performance addressing display, thin-film transistor display, organic light-emitting diode display, surface-conduction electron-emitter display, laser TV, carbon nanotubes, quantum dot display, interferometric modulator display, and the like. Thus, a display of any device 101, 105, 106 may generate and/or present interfaces or a web portal to a user, such that the user may interact with and receive information from other computing devices 105, 106 or the system device 101.

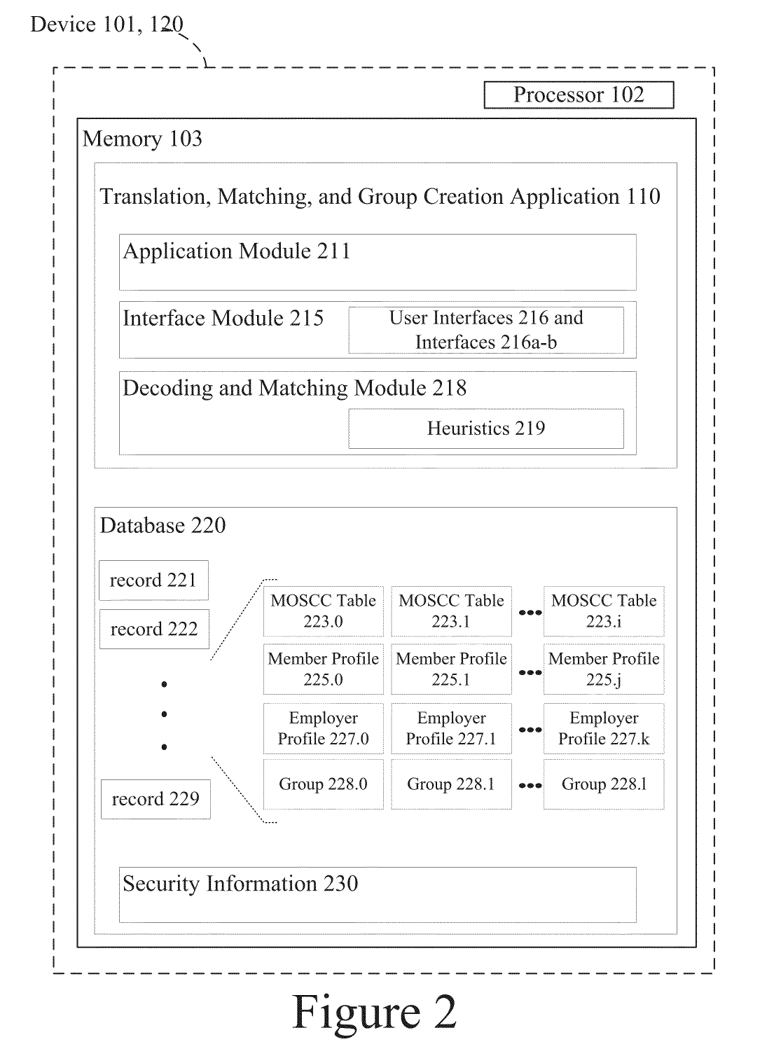

The system device 101 and computing devices 105, 106 may further utilize the processor 102 to operate a decoding, matching, and group creation application 110 (e.g., application 110 of FIG. 2 described below) to perform the operations of receiving inputs, data, and records; accessing other modules, applications, and devices; extracting data, codes, and profile characteristics; processing data, codes, and profile characteristics; associating data, codes, and profile characteristics; utilizing heuristics and tables; matching records, e.g., profiles with job postings; generating interfaces; communicating with other devices, etc.

For example, the system device 101 may also be any hardware that includes a processor 102 and a memory 103 and automatically receives an indication that identifies a member profile; access the identified member profile and other records related to the identified member profile; extract codes from the identified member profile; access tables based on the extracted codes; decode the codes based on the accessed tables into plain language; associate the identified member profile with the plain language; extract profile characteristics from the identified member profile; utilize a heuristic to make inferences form the extracted profile characteristics; associate the identified member profile with the inferences; utilize the plain language, the inferences, or combination thereof to automatically match the identified member profile to instances of a plurality of content; and generate interfaces that presents the identified member profile, the plain language translation, the inferences, the matched instances, etc. Further, the system device 101 may be a server.

In general, a server may be any computing system and/or device (as described above) acting as databases, data repositories or other data stores that includes any type of data structure, source, and/or file system that manages and record, such as records 221-222 and security information 230 described below. The server may also include a data management client, along with licenses (e.g., a license that permits control and access of a decoding, matching, and group creation application 110 by the computing devices 105, 106) relating to data management access and/or configurations. Thus, a device management client may include executable instructions that manage the communications (e.g., communication A1-2, B, C) with computing devices 105, 106 by setting configurations and diagnostics based on a particular protocol.

Further, databases, data repositories or other data stores (e.g., storage device 120, external device 121, and/or database 220 of FIG. 2 described below) described herein may generally include various kinds of mechanisms, including a hierarchical database, a set of files in a file system, an application database in a proprietary format, a relational database management system (RDBMS), etc., for storing, providing, accessing, and retrieving various kinds of data. Data may include the records and the information contained therein. The records may further be identified by an identifier, such as a user name, family name, call-sign, identification number, and/or other information unique to the record.

Each such data store may also generally be included within or external to a computing system and/or device (e.g., the devices 101, 105, 106, 120, 121) employing a computer operating system such as one of those mentioned above, and/or accessed via a network (e.g., systems 140A-B) or connection in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above. Thus, the storage device 120, external device 121, and/or database 220 of FIG. 2 may, for example, include at least one of a tax databases, public record databases, military databases, job posting databases, employer databases, entrepreneur databases etc.

Systems 140A-B may be a network that provides the infrastructure through which the devices 101, 105, 106, 120, 121 communicate. In general, a network (e.g., system 140A-B) may be a collection of computers and other hardware to provide infrastructure to establish virtual connections and carry communications. For instance, a network may be an infrastructure that generally includes edge, distribution, and core devices (e.g., tower 141 or network device 143) and enables a path (e.g., connections 144-151) for the exchange of information between different devices and systems (e.g., between the devices 101, 105, 106, 120, 121 of the scheme 100). Further, a network may be any conventional networking technology, and may, in general, be any packet network (e.g., any of a cellular network, global area network, wireless local area networks, wide area networks, local area networks, or combinations thereof, but may not be limited thereto) that provides the protocol infrastructure to carry communications. The systems 140A-B are representative, and thus while a single cloud illustrates the system 140A and a single block illustrates the system 140B, these illustrations may represent a single network, a combination of different networks components and technologies, and/or a plurality of networks, as described above.

The tower 141 may be a tall structure designed to support antennas or aerials for telecommunications amongst the scheme 100. The tower 141 may enable the connection 147 that carries signals to or from the system 140A and the transceiver 142 of the computing device 106. In additional or alternative aspects, some or all of the functions of tower 141 may be performed instead by a different distribution structure, such as a satellite.

The transceiver 142 may be any connector used for digital or analog signal transfers. For instance, the transceiver 142 may be any antenna technology, such as cellular, Wi-Fi, or the like, that implements a wireless exchange of data by converting propagating electromagnetic waves to and from conducted electrical signals. Further, the transceiver 142 may be an antenna technology that implements Wi-Fi, near field communication, Bluetooth®, or the like, which is used to exchange data wirelessly using radio waves over a shortwave radio range or network that enables direct communication.

Network devices 143 may be a computing system and/or device, as described above, that are gateways between connections of the scheme 100. For instance, a communication path between the system device 101 and external device 121 is completed by the network devices 143 and the connections 149-151. Additional examples of computing systems and/or devices with respect to the network device 142 include, without limitation, networking hardware such as gateways, routers, network bridges, switches, hubs, repeaters, multilayer switches, protocol converters, bridge routers, proxy servers, firewalls, network address translators, multiplexers, network interface controllers, wireless network interface controllers, modems, ISDN terminal adapters, line drivers, wireless access points, networking cables and the like.

The connections 144-151 may be wired or wireless connections between two endpoints (devices or systems) that carry electrical signals that facilitate virtual connections. Examples of connections 144-151 may be any transmission media including electromagnetic waves (e.g., radio waves or infrared waves), metal wire, fiber optics, and the like. Virtual connections are comprised of the protocol infrastructure that enables communication (e.g., communications A1-2, B, C) to and from the devices 101, 105, 106, 120, 121. Thus, the connection 144 may be a wired connection between the computing device 105 and the network device 143; the connection 145 may be a wired connection within the system 140A between the system device 101 and the network devices 143; the connection 146 may be a wired connection within the system 140A between the system device 101 and the storage device 120; the connection 147 may be a wireless connection between the tower 141 and the transceiver 142; the connection 148 may be a wired connection within the system 140A between the tower 141 and the system device 101; the connection 149 may be a wired connection within system 140B between the network device 143 and the external storage device 121; the connection 150 may be a wired connection between the network device 143 of system 140A and the network device 143 of system 140B; and the connection 151 may be a wired connection between the network device 143 and the system device 101 within system 140A. Further, the combination of connections 144-151 support the virtual connections of the scheme 100, and therefore, any device 101, 105, 106, 120, 121 may communicate with another device 101, 105, 106, 120, 121 based on a need of the scheme 100.

Thus, according to scheme 100, the computer network operates in a manner different from its normal, expected manner of data-in data-out by automatically decoding codes, automatically associating decoded information with member profiles, automatically and intelligently matching member profiles with third parties, and automatically presenting user interfaces to the user.

FIG. 2 illustrates a decoding, matching, and group creation application 110 (application 110) and a database 220 stored on a memory 103 of any of the devices 101, 120 (as illustrated by the dashed-box).

The application 110 is configured to process codes and profile characteristics of any record corresponding to provide intelligent matching services. The application 110 includes an application module 211, an interface module 215 that generates user interfaces 216 (e.g., interfaces 216A-L), and a decoding and matching module 218 that utilizes/manages heuristics 219. The application 110 may enable searching for and joining of groups. By receiving a selection of one of the search results, the application 110 may automatically associate the member profile with other dentists from the air force and/or other military branches, which enables career mentoring and advancement, transition, and other digital conversations. Further, when member profiles have multiple MOSCCs, the application 110 may group the member profiles by their primary and secondary MOSCC to enable and empower digital conversations, member linking and biographical profile discovery, and need for support/help with their employment transition (Military to civilian life) challenges. The application 110 may operate as an organic “learning” system that adapts based on new codes added to the system and/or the success and failures of data matching. The application 110 leverages the internal “crowd” or community (e.g., combination of records of the database) to achieve a high level of data accuracy, matching, and decoding effectiveness. For example, the application 110 may receive a MOSCC and customize the interface 216 so that content based on the received MOSCC is displayed.

Although one modular breakdown of the application 110 (and database 220) is offered, it should be understood that the same functionality may be provided using fewer, greater, or differently named modules. Further, although it is not shown, the interface module 215 and the application module 218 may be integrated with any of the above named modules.

In one schematic example, a single computing device, such as the system device 101, may be independently configured to include the entire operability of the application 110 and database 220, as illustrated in FIG. 2. Thus, the application 110 may generally be operated independently by one of the devices 101, 105, 106.

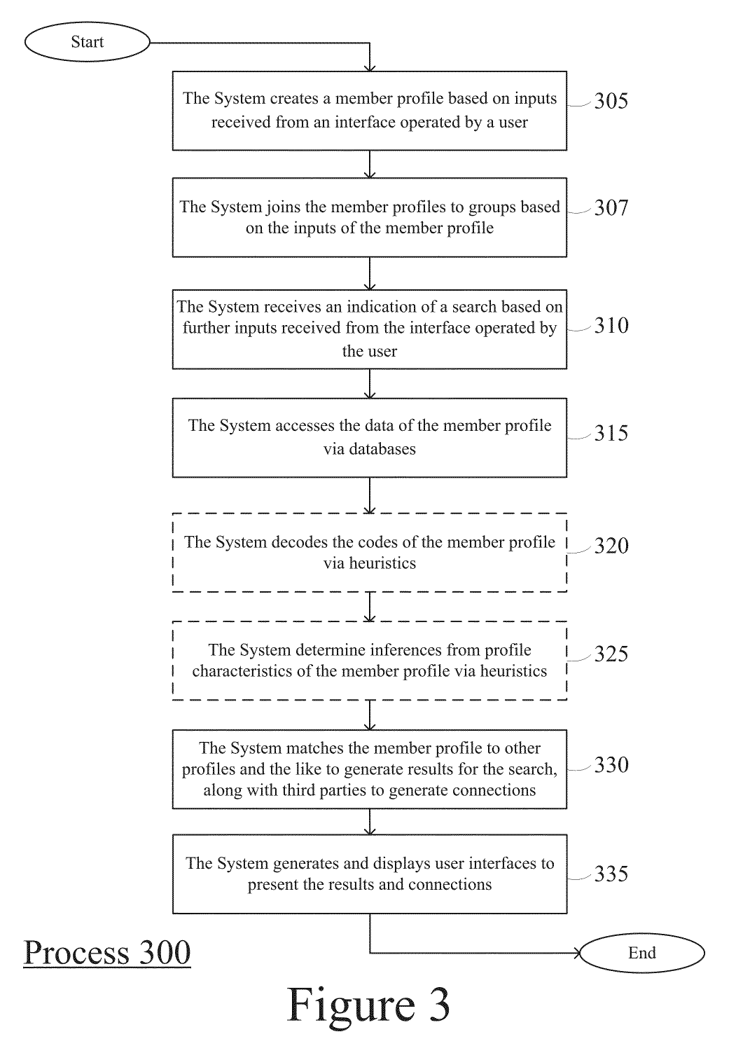

For instance, one operational example will now be described with reference to FIG. 3 where a member profile is utilized by the application 110 for matching specific content to a profile. In operation, the decoding and matching module 218 of the application 110 creates at step 305 a member profile based on inputs received via the user interface 216 of the interface module 215 operated by a user, where the initial inputs may include a username and authorization credentials that uniquely identify that user. The decoding and matching module 218 of the application 110 automatically joins or associates at step 307 the member profile based on the inputs of the member profile to groups (e.g., based on their shared past job experience, education, and professional career interests according to the codes and profile characteristics of the member profile created in block 305). The application 110 further receives at step 310 an indication of a search (e.g., job, education, group, searches) based on further inputs received via the user interface 216 of the interface module 215, which enable the execution of searches based on the member profile. The application 110 then accesses at step 315 via application module 211 the data (e.g., the codes and the profile characteristics) of the member profile via database 220. Once accessed, the application module 211 of the application 211 may optionally (as illustrated by the dashed-box) decode at step 320 the codes of the member profile by utilizing tables, as described below, of the database 220 into plain language (e.g., a first dataset). In addition, the System may optionally (as also illustrated by the dashed-box) determine at step 325 inferences (e.g., a first dataset) from profiles characteristics of the member profile via heuristics 219. The decoding and matching module 218 of the application 110 matches at step 330 the member profile to employers to generate results for the search, along with matching the member profile to third parties (e.g., jobs, educational content, groups, etc.) to generate connections based on at least one of the decoded codes or derived inferences (e.g., the first dataset). The interface module 215 of the application 110 generates and displays at step 335 user interfaces to present the results and connections.

As an alternative schematic example, the operability of the application 110 may be divided between the devices 101, 105, 106, 120, 121 where modules 211, 215, 218 may be located separately or duplicated on different devices 101, 120 and accessed through connections 144-151 via distributed computing, such that the operability is provided for, shared, and relied upon by other devices 101, 105, 106, 120, 121. Thus, the application 110 may generally be divided between the devices 101, 105, 106, 120, 121 where modules 211, 215, 218 may be duplicated on different devices and accessed through connections 145,146, 148-149. For example, the application 110 of the computing device 105 may utilize a user interface 216 to receive an input or indication (from a user who desires to search for a job) that includes a code. The system device 101 and the computing device 105 may communicate A1 via their respective applications 110 to transfer the indication. The application 110 of the system device 101 may decode the code of the indication to into plain language based on tables from the database 220 of the internal memory 103 and/or via communicating (e.g., communications B, C) with the storage device 120 and the external device 121. Based on the plain language, the application 110 of the system device 101 may match the member profile to employers to generate results for the job search. Further, the system device 101 and the computing device 105 may again communicate A1 via their respective applications 110 to transfer the results, which the application 110 of the computing device 105 in turn utilizes to generate an interface 216 that presents the results.

The items of the schematic 100 of the decoding, matching, and group creation application 110 will now be further described with references to FIG. 2.

The application module 211 is any application programmable interface or application binary interface that includes a set of executable instructions configured to facilitate communication between the modules of the application 110 and hardware/software components external to the application 110, including the devices 101, 105, 106, 120, 121. Examples application programmable and application binary interfaces include POSIX, Microsoft Windows API, Java API, Linux Standard Base, and the like. That is, the application module 211 may be configured to communicate directly with other applications, modules, models, devices, systems, and other sources through both physical and virtual interfaces. Further, the application module 211 may include executable instructions and specifications for routines, data structures, object classes, and variables that receive, package, present, and transfer data through connections 144-151 or through systems 140A-B. For example, the application module 211 may be configured to receive inputs from the interface module 215 or sources external to the system device 101 and forward the inputs to the decoding and matching module 218 for processing.

The application module 211 may also manage the dispatching and receipt of data/information along with integrating the application 110 with other applications and drivers, as needed per operating system. A driver may be a computer routine that controls a particular physical component of device or a peripheral (e.g., a printer, display, or the like) attached to the device. Thus, the application module 211 may manage and translate input/output requests into data processing instructions for the central processing unit (e.g., processor 102) and may include a set of executable instructions that itemizes and implements the data structures, object classes, and variables that interact with the drivers to operate physical components and that launch routines and/or programs (e.g., send and receive instructions/data/information to and from the system device 101, the computing devices 105, 106, the storage device 120, and/or external device 121).

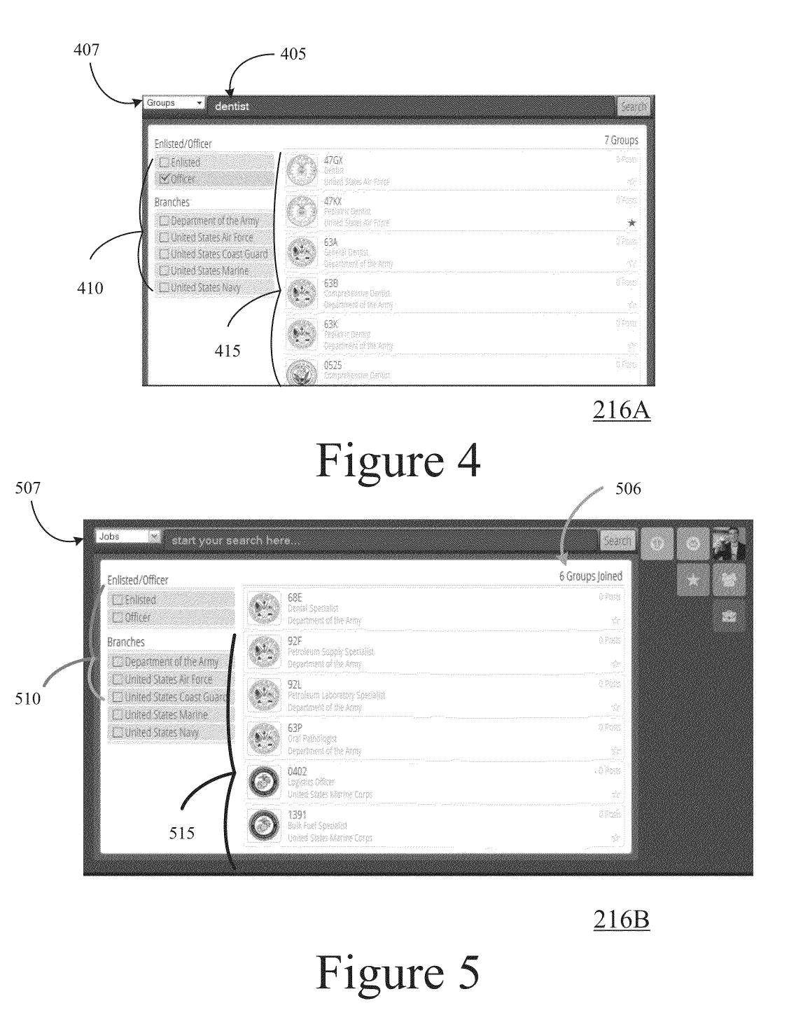

The interface module 215 is an application programmable interface that includes a set of executable instructions for generating and managing user interfaces 216, which receive inputs and present information. For instance, the interface module 215 may be configured to generate, present, and provide one or more user interfaces 216 in a menu, icon, tabular, map, pop-up, grid format etc. (e.g., as illustrated in FIGS. 4-15) in connection with other modules for presenting information and receiving inputs (e.g., indications of altering, updating, or changing the codes, profiles characteristics, and/or user preferences on records 221-222). The inputs received by the user interfaces 216 may generally be communicated by interface module 215 to the application module 211, which in turn forwards the inputs to the decoding and matching module 218 for processing.

The user interfaces 216 may include any presentation of information or data, such as suggested groups or search results, through a display (as described above), whether graphic or otherwise, where interaction between a user and the application 110 occurs. Examples of user interfaces 216 may include the data manipulation interfaces, graphical user interface (that allows users to interact with electronic devices through graphical icons and visual indicators), touchscreen interfaces, text-based interfaces, typed command labels or text navigation. The user interfaces 216 may receive inputs indicating user selections and/or user instructions, e.g., inputs indicating codes for translation into plain language that is presented by the user interfaces 216. The user interfaces 216 may also include any presentation of information or data through frame, fields, banners, icons, badges, alerts, sounds, text, or any combinations thereof. A frame may be a reserved space of an interface that presents alphanumeric text and/or graphical items presenting records 221-222 and may also be a mechanism for receiving input that causes the application 110 to perform additional operations. A field may be a reserved space of an interface that presents alphanumeric text and/or menu items records 221-222 and may also be a mechanism for receiving input that causes the application 110 to perform additional operations. A banner may be a media or drop-down menu that extends from a top portion of an interface, a sub-interface, and/or display and that may include text, badges, and animated symbols. An icon and/or a badge may be a number or symbol that signals a link, an event, or a number of events. An alert may be a pop-up window that may be oriented within the display (e.g., centered) and that may include text, badges, and animated symbols.

Thus, the interface module 215 may generate new and unique user interfaces 216 particular to the application 110. That is, the interface module 215 may also commandeer or utilize interface formatting local to the device in which the application 110 is stored thereon (e.g., appropriating interfaces of the devices 101, 105, 106). The interface module 215 may also provide remote interface formatting for a device in which only a portion of the application 110 is stored thereon (e.g., providing web portal interfaces for computing devices 105, 106 through which the system device 101 may provide information and receive inputs). The interface module 215 may thus generate or utilize local, terminal, web-based, and mobile interfaces and any similar interface that presents and receives information relative to the devices 101, 105, 106.

FIGS. 4-15 illustrate exemplary interfaces 216A-L generated by the interface module 215 of the decoding, matching, and group creation application 110.

FIG. 4 illustrates an interface 216A of a group listing based on an input of the term ‘dentist’ in the search bar 405. Interface 216A further includes a drop down menu 407, filters 410 and results 415 that display the search results. Thus, a user may input the term ‘dentist’ into the search bar 405 and receive the results 415 related to this term. Note that while six MOSCC(s) (e.g., 47GX, 47KX, 63A, 63B, 63K, and 0525) are illustrated, the search of the application returned seven hits—indicating that the interface is scrollable.

FIG. 5 illustrates an interface 216B of a groups joined listing 506 that includes a drop down menu 507, filters 510, and results 515. Note that this example shows six groups that the user has been auto-joined based on inputting each of these six codes into their member profile. Further, if a user inputs a MOSCC code into their profile, then they may be auto joined to an online group with every other user of the same MOSCC code (e.g., the decoding and matching module 218 of the application 110 automatically joins or associates (step 307) the member profile based on the inputs of the member profile to groups). Note also that similar groups may be suggested by the application 110 and joined by the users.

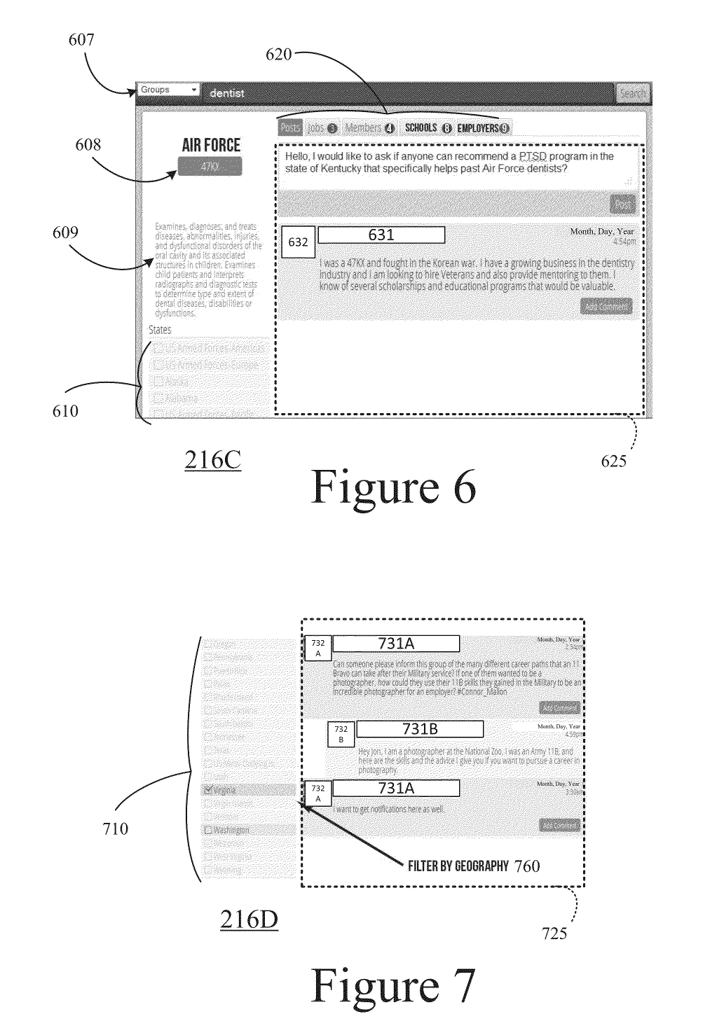

FIG. 6 illustrates an interface 216C that includes a drop down menu 607, MOSCC icon 608, MOSCC description 609, filters 610, tab menu 620 (which may also include an entrepreneur tab), and a frame 625. Note that because the ‘Posts’ tab is selected from the tab menu 620, the frame 625 shows the posts associated with the MOSCC displayed by interface 216C. Further, name block 631 may relate to an identifier of a profile that listed the post, while graphic 632 may be any graphical representation of the profile that listed the post.

FIG. 7 illustrates an interface 216D that includes filters 710 and frame 725. In this example, the posts were filtered by geography 760 (see the check box with regard to Virginian). Further, name block 731A and graphic 732A may relate to a profile that listed first and third posts, while name block 731B and graphic 732B may relate to a profile that listed a second post.

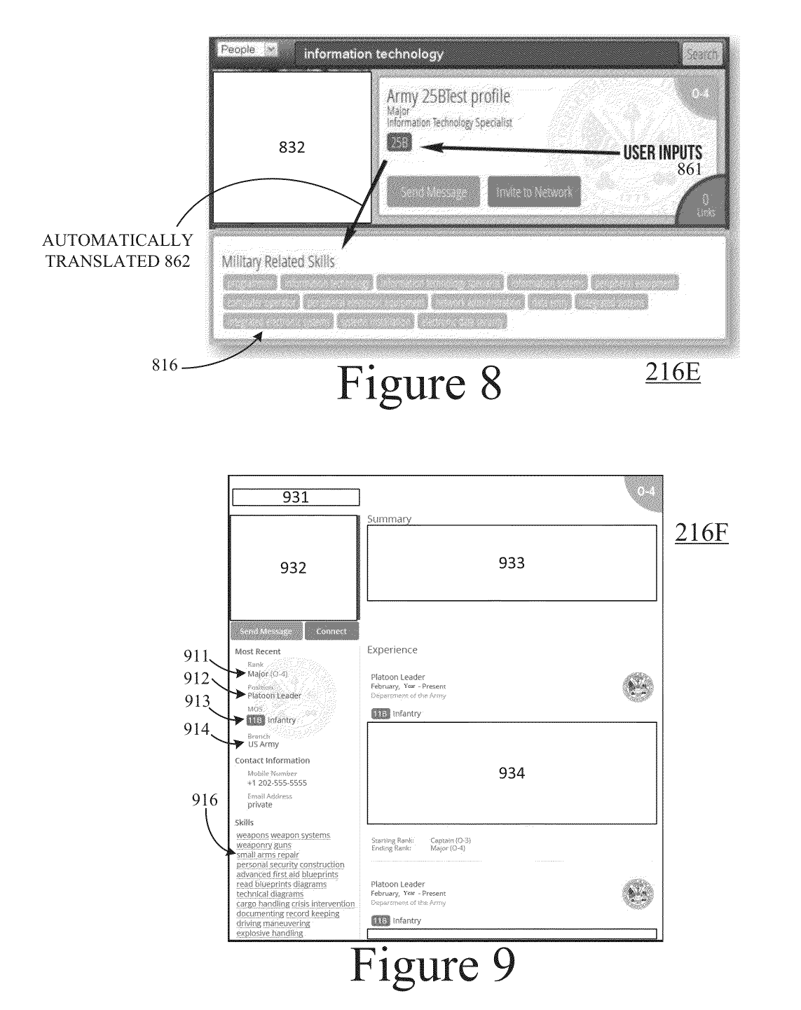

FIG. 8 illustrates an interface 216E of a member profile that includes the result of an automatic decoding 862 of a user input 681 (e.g., MOSCC ‘25B’) to plain language 816, where a profile is automatically populated based on the decoding. Graphic 832 may be any graphical representation of the profile presented by interface 216E.

FIG. 9 illustrates an interface 216F of a member profile that includes the result of an automatic decoding of a user input (e.g., MOSCC ‘11B) to plain language 916, where a profile is automatically populated based on the decoding. Interface 216F also displays profile characteristic 911-914. Name block 931 may be any relate to an identifier of the profile presented by interface 216F. Graphic 932 may be any graphical representation of the profile presented by interface 216F. Text block 933, 934 may include information related to the profile presented by interface 216F.

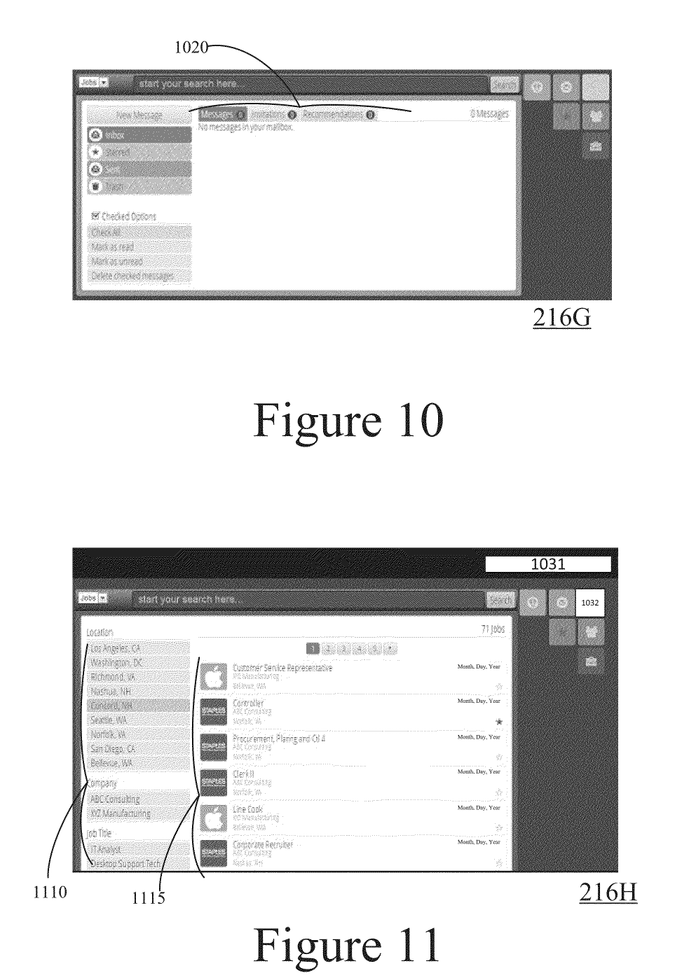

FIG. 10 illustrates an interface 216G that includes tab menu 620 which illustrates that no recommendations have been by the application 110 as a result of the absence of a search term in the search bar.

FIG. 11 illustrates an interface 216H that includes filters 1110 and results 1115 with respect to an automatic associated of jobs with a profile presented by the interface 216H. Further, name block 1031 may relate to an identifier of the profile presented by the interface 216H, while graphic 1032 may be any graphical representation of the profile presented by the interface 216H.

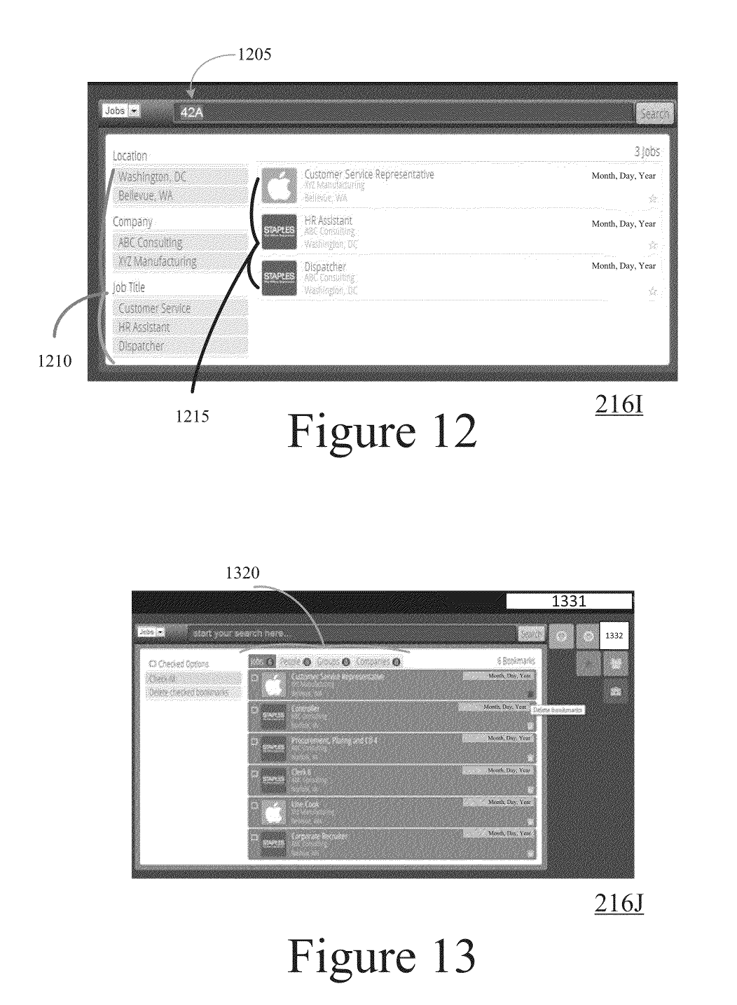

FIG. 12 illustrates an interface 216I that includes filters 1310 and results 1215 with respect to an automatic associated of jobs with MOSCC ‘42A’ within the search bar 1205.

FIG. 13 illustrates an interface 216J that includes tab menu 1320 (which may also include an entrepreneur tab) for a profile that has previously had the automatic decoding of the MOSCC(s). Further, name block 1331 may relate to an identifier of the profile presented by the interface 216H, while graphic 1332 may be any graphical representation of the profile presented by the interface 216J.

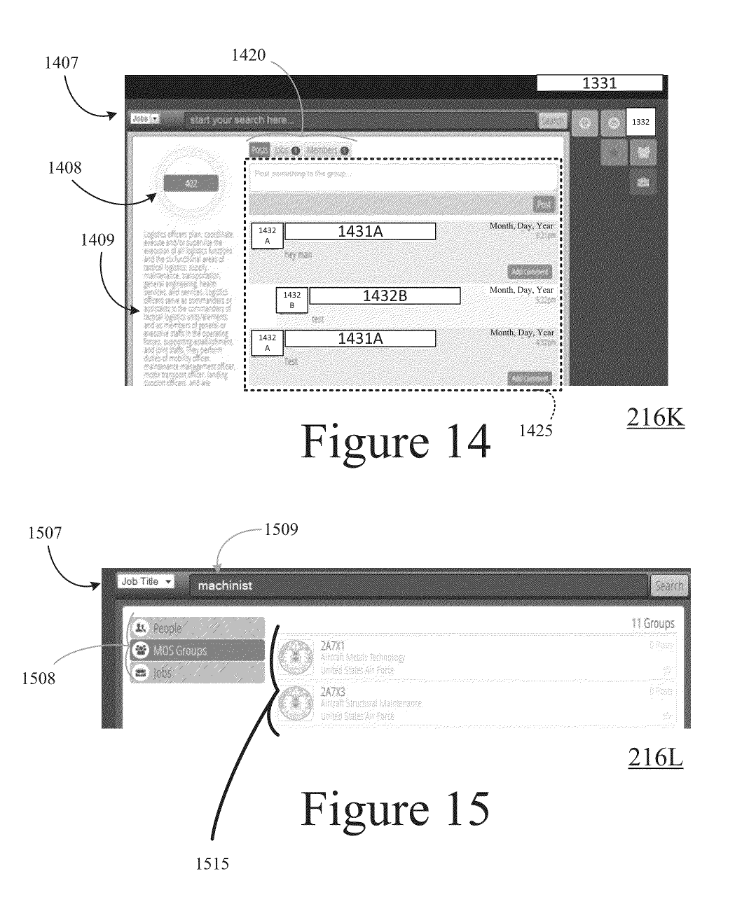

FIG. 14 illustrates an interface 216K that includes a drop down menu 1407, MOSCC icon 1408, MOSCC description 1409, tab menu 1420, and frame 1425, which presents individual posts.

FIG. 15 illustrates an interface 216L that includes a drop down menu 1507, a button menu 1508, a search bar 1509, and results 1515.

Thus, the interface module 215, user interfaces 216, and interfaces 216, 216A-L of the application 110 may enable the presentation of information, such as suggested groups and/or jobs, for a member profile to assist in intelligently matching user of like experience.

The decoding and matching module 218 includes a set of executable instructions configured to perform accessing, processing, translating, decoding, associating, generating, and presenting—along with evaluating and refining—operations. The decoding and matching module 218 is configured to decode codes of profiles into common language and to derive inferences (e.g., derive leadership qualities from rank) from characteristics of the profiles in support of matching the profiles to specific content related to a work opportunities, educational training, other profiles, entrepreneurial prospects, and geographic resources. The decoding and matching module 218 further automatically matches the combination of common language and/or inferences to specific instances of a plurality of content (e.g., job posting, continuing education classes, other profiles, entrepreneurial prospects, and geographic resources) and provides the matched instances via a user interface 216. The decoding and matching module 218 may include a MOSCC heuristic 219 that access a MOSCC database (e.g., database 220) to decode MOSCCs of Veteran and U.S. active Military member profiles into common language that can be used to match these member profiles to specific content.

The decoding and matching module 218, in addition to decoding and matching, consolidates and matches member profiles to relevant digital content and groups via a heuristic. That is, the decoding and matching module 218 receives via user inputs, e.g., criteria/information, and response by performing different search and match operations. Utilizing the military example above, the MOSCC heuristic may operate as seen in Table 1. Table 1 provides examples of how the decoding and matching module 218 may utilize MOSCC heuristic may decode MOSCC(s) into common language keywords, generate profile matches between member profiles and the like, and associate tax and legal compliance flags with Military (past and present) profiles, along with performing other search and retrieve operations in connection with the MOSCC Database.

TABLE 1

| Database of Profiles | Search and Match By | Output and Display | Communities created |
|---|---|---|---|
| Networking from | MOSCC codes entered and groups | Different Device Screens | Mentoring |
| internal “social | joined | Laptop | Affinity groups |
| network” function. Link | | Desktop | Career transition |
| and unlink to any | | Mobile Devices | connections |
| member see your links, | | Tablets | Educational |
| see your links' links - | | Google glass | programs |
| and be able to | | Microsoft surface | |
| message/email and other | | Foldable displays | |
| features to your links | | | |
| and your links' links. | | | |
| Third Party Web Site | Content imported from existing third | Highly personalized | Recommends communities |
| API Integration | party API | content (Veteran and Employer) | based on content |
| Translator | Translates military | Qualified candidates for | Groups users into communities |
| | occupations to equivalent civilian | employer's job postings | by MOSC, Occupational Field, |
| | terminology | | and Military Branch |
| | Translates military | | |
| | performance reviews, awards, | | |
| | certificates, training, leadership | | |
| | levels | | |
| Task Management | Match Veteran candidates to | Qualified candidates | |
| | employment opportunities based on | | |
| | tasks required by employers. | | |
| User Location | Location | Veteran and Employer | Local communities are created |
| | Local and/or National area | profiles that match location | based on their geographic radar |
| | Search and match based on | criteria | and dynamically changing |
| | user input (i.e. within 25 miles of | Civilian jobs that match | physical presence. |
| | location) | location criteria | Customizable privacy settings. |
| | | Overlay data as API for | |
| | | Augmented Reality and other | |
| | | mapping | |
| | | Integrate Google glass | |
| | | Integrate SocialRadar.com | |
| Capabilities | Capabilities | Veteran profiles and civilian jobs that | Specific connections with |
| | User selects capabilities | match capabilities criteria | employers, schools, and |
| | | | support organizations. |
| Competencies | Competencies | Veteran profiles and civilian jobs that | Specific connections with |
| | User selects competencies | match competencies criteria | employers, schools, and |
| | | | support organizations. |
| Leadership | Leadership | Veteran profiles and | Specific connections with |
| | User selects leadership | civilian experience that match | employers, schools, and |
| | requirements | leadership criteria | support organizations and other |
| | | Civilian jobs that match | Veteran users for mentoring. |
| | | leadership criteria | |
| Certificate of Release or | Verified veterans to civilian employers | Veteran verified through digital | Communities of verified |
| Discharge from Active | | verification tool such as TroupID/ | Veterans created. Digital |
| Duty (currently Form | | and/or ID.me or our own internal | badges of verification for |
| DD 214) or equivalent | | verification methods. | employment, tax purposes, |
| document | | | VEVRAA compliance, |
| | | | education, and more. |
| Verification of Military | Additional Required skills, experience, | Qualified candidates | Enhanced matching and |
| Experience and Training | and training is obtained | | recommended connections. |
| (currently Form DD | | | |
| 2586) or equivalent | | | |
| document | | | |
| User MOSC code | MOSC | Qualified candidates | Auto Groups users |
| | | | into communities by their |
| | | | MOSC, Occupational |
| | | | Field, and Military Branch |
| | | | Creates mentoring |
| | | | opportunities within |
| | | | communities |
| Occupational Field or | Occupational Field or equivalent | | Groups users into |
| equivalent | | | communities by MOSC, |
| | | | Occupational Field, and |
| | | | Military Branch |
| | | | Creates mentoring |
| | | | opportunities within |
| | | | communities |
| Fitness Reports | Competency and capability | Qualified candidates | |
| Code Proficiency and | Code Proficiency and Conduct Marks | Qualified candidates | |
| Conduct Marks | | | |
| Verification tool | Troop ID/ID.me or other Veteran status | Verified Veterans | |
| Veteran status | verification methods or internal system | | |
| verification system | | | |
| Personal Interests | Personal Interests | | |
| Skills Assessments | Skills Assessments | Qualified candidates | |
| Interest Assessments | Interest Assessments | Qualified candidates | |
| Pre-employment | Pre-employment personality assessment | Qualified candidates | |
| personality assessment | | | |
| Education | Degrees or certificates | Qualified candidates | |
| Training | Training in a specific skill | | |
| | (i.e. MS Excel, Six Sigma, Lean, | | |
| | and etc.) | | |
| Candidate Ranking | Most viewed candidate | Most qualified candidate based on | |
| | Highest skills match | search and match criteria | |
| | Highest Educational match | | |
| Candidate Rating | Employer can rate potential candidates | Candidate list showing top rated | |
| | on a scale of 1 thru 5 | candidate and descending to bottom | |
| | | rated candidate | |
| VEVRAA | | Report on VEVRAA compliance for | |
| | | Employers | |
| Veteran hiring tax | | Report for tax credit filing | |
| credits | | | |
| Suggest a keyword | System learns behavior based on user | Highly personalized content | |
| (Crowd Source) | input. User input will create a unique | | |
| | taxonomy that will not be available in | | |
| | any other system | | |
| Occupational Groups as | Occupational Groups (i.e. | Candidates within specific | Auto groups users into |
| defined by the Bureau | health care occupations, support | Occupational Groups Suggestions | communities by their |
| of Labor Statistics in the | service occupations)Factor in | on training | Occupational Group |
| Occupational Outlook | previous work experience and their | Resources | |
| Handbook Professional | desire to transition to another career | Logical Career path | |
| interests or desired | path | displayed | |
| career path | User may select the level of career path | | |
| | information that influences the | | |
| | matching process | | |
| Suggest a Keyword | Keywords associated with MOSCC | Improved | |
| Functionality | | Veteran/employer/recruiter/educator | |
| | | matches based on Crowd sourcing of | |
| | | keywords | |

The decoding and matching module 218 is also configured to create records, such as building a member profile for a user by requesting and receiving a username, authorization credentials, codes (e.g., MOSCC(s)), and profile characteristic (e.g., Characteristics). For example, the decoding and matching module 218 may automatically decode a received MOSCC(s) into common language keywords and populate the member profile for the user. Populating the profile may include utilizing the common language keywords to match civilian employers and/or civilian jobs with the profile.

The decoding and matching module 218 may enable the users to customize their members profile such that additional or alternative employers and/or third parties may be recommended. The decoding and matching module 218 may utilize the customizations to enhance and alter the records to support future matches. In addition, the decoding and matching module 218 may associate tax identification number with employer job postings to enable automatic tax credit receipts.

The decoding and matching module 218 may enable searching for and joining of groups. In the case where a user has multiple MOSCCs associated with their member profile, the decoding and matching module 218 enables a search option to find an appropriate MOSCC(s). By receiving a selection of one of the search results, the decoding and matching module 218 may automatically associate the member profile with other profiles of dentists from the air force and/or other military branches, which enables career mentoring and advancement, transition, and other digital conversations. Further, when member profiles have multiple MOSCCs, the decoding and matching module 218 may group the member profiles by their primary and secondary MOSCC to enable and empower digital conversations, member linking and biographical profile discovery, and need for support/help with their employment transition (Military to civilian life) challenges. The decoding and matching module 218 may further implement privileges, filters, and the like.

The decoding and matching module 218 may, in conjunction with the application module 211, scan database 220 to aggregate all of the records 221-229. That is, in general, the decoding and matching module 218 may present a user with the most up to date information because it includes all records in an analysis from the moment the analysis begins. The decoding and matching module 218 may further dynamically update the analysis to include records when new records are added to the database 220. In support of the operations above, the decoding and matching module 218 may further receive indications through the interfaces module 215 and/or application module 211 that instruct the application to perform operations, as described herein.

The database 220 may be representative of multiple sources that includes multiple types of records. For instance, a database 220 may be a database of keywords and/or a database of groups, such that as users remotely or locally communicate with the application 110 the database of keywords and/or a database of groups are referenced and utilized by the application 110 to connect that user with other records, content, etc. (e.g., job postings and work opportunities, continuing education classes and educational training, other profiles, entrepreneurial prospects, and geographic resources). A record may be an electronically stored document and/or file that includes multiple instances of data (e.g., job postings and work opportunities, continuing education classes and educational training, other profiles, entrepreneurial prospects, groups, and geographic resources). Records, in general, may be identified by an identifier, such as a name, physical address, identification number, and/or other information unique to the record. Thus, the database 220 may store and manage one or more records 221-229 of the multiple sources. While the records 221-229 are exemplary, the database 220 may have different types and/or amounts of records 221-229, examples of which include MOSCC Tables 223.0-223.i, member profiles 225.0-225.j, employer profiles 227.0-227.k, and groups 228.0-228.l. The notations of ‘i,’ ‘j,’ ‘k,’ and ‘l’ indicate a plurality of records for a category stored on the database 220.

In general, each record 221-229 may include information related to the decoding and matching of records such that multiple instances of content may be provided to a user. Utilizing the military example above, an example of databases may include an MOSCC database that stores records, such as tables, profiles, connections, and the like (each having a unique field set). In turn, e.g., a first record—Member Profile 225.0—may provide a MOSCC that is decoded via a second record—MOSCC Table 223.0 of an MOSCC database—to enable the first record to be matched to a third record—Employer Profile 227.0). Thus, the system device 101 (and alternatively the devices 105, 106, 120, 121), as described above, may include various kinds of mechanisms for storing, providing, accessing, and retrieving various kinds of records 221-229 from a database 220, such as MOSCC Tables 223, member profiles 225, employer profiles 227, and groups 228.

One example of a MOSCC Table 223 (e.g., Table 2 below), which is utilized by a MOSCC database to manage a voluminous amount of codes, e.g., over 20,000 MOSCC(s) (including legacy and new MOSCC(s)), where each MOSCC may be associated with at least five common language keywords per content category, profiles, and tax entries.

TABLE 2

| | | | | Sub- | | | | | |
|---|---|---|---|---|---|---|---|---|---|
| Table Row | Branch | Officer | MOSCC | Branch | Title | Category | Soft Skills | Keywords | Complete Description |
| 240 | USAF | O | 47XX | Medical | Pediatric | medical | Leadership, problem | Child dentist, | Examines/diagnosis/treats |
| | | | | | Dentist | | solving, coaching, | children's dentist, | diseases, abnormalities, |
| | | | | | | | mentoring, strategic | special needs, | injuries, and dysfunctional |
| | | | | | | | thinking, decision | handicap, children, | disorders of the oral |
| | | | | | | | making, critical | adolescent, | cavity and its associates |
| | | | | | | | thinking, team | dentistry . . . | structure . . . |
| | | | | | | | building . . . | | |

A MOSCC table field set may include MOSCC(s), Keywords, Occupational Groups, Occupational Fields, Officer vs. Enlisted, Soft Skills, Complete Description, Short Description, Branch Description, Title, Job Categories, Rank, Time Period, Leadership Level, and Specialty. MOSCC(s) are alphanumeric code(s) or identifiers that are particular to a job within a military branch, such as the United States Army, United States Marines, United States Air Force (which utilizes Air Force Specialty Codes), the United States Navy (which utilizes ratings and designators along with the Navy Enlisted Classification system), and the United States Coast Guard. MOSCC(s) may also be an abbreviation, such as when a branch utilizes a nine character sequence to designate a job, a MOSCC may be a three character string pointing to the associated nine character sequence. MOSCC(s) may also include duty military occupational specialty codes, which are utilized to identify a primary job function when an individual obtains multiple job specialties at the same time. Keywords are plain language word(s) that is utilized as an identifier, variable, or label for organizing, searching, and/or accessing records (or other data structures within the database). The Keywords field may include a set of plain language words selected from the list of common words utilized to describe a particular job. For example, if an employer wants to search for “Plumber,” then the Keywords indicating the job skills related to “Plumber” will be utilized to find the MOSCC(s) (and Occupational Groups as defined below) and in turn the member profiles associated to the MOSCC. Occupational Groups are departments or sectors within a military branch, and may be automatically assigned to profiles based on MOSCC(s). Officer vs. Enlisted is a field that indicates a military track or career path, where each track has a minimum requirement. Enlisted may be individuals with at least a high school diploma (or general educational development certification) that may progress through a system of enlisted ranks (generally, nine ranks). Officer may be individuals with at least bachelor level degree (unless promoted from Enlisted) that receive special training to start as supervisors in armed forces that command enlisted men. Leadership Level is a correlation factor that relates military management experience to civilian management experience. Specialty is a sub-sector category that further defines the MOSCC(s), e.g., medic vs. infantry.

A record may be any profile—as in a member profile 225, such as Veterans and U.S. Active Military (verified and unverified), or an employer profile 227, such as a company, a university, or the like. A member profile field set may include MOSCC(s), Occupational Groups, Customized Keywords/Occupational Groups, Display Settings, Recommendations, and Tracking Pointers.

Multiple MOSCC(s), as defined above, may be associated with a single profile, group, and/or connection. Customized Keywords/Occupational Groups and keywords and occupational groups, as defined above, that may be further altered by a user to more accurately describe the MOSCC(s) associated with their profile. For example, because a Veteran may desire to work in an industry not associated with their MOSCC(s), the Veteran may customize the Veteran's profile settings to reflect desires, interests, values, and education for other workforce areas and industries. Further, a Veteran may desire to join or leave a group, such that the Veteran may communicate with others who may have experience or have insight regarding their career struggles. Customization may be further utilized to support the organic “learning” system. Display Settings are color coding, flags, banners, badges, notifications, and other visual settings that may be employed on a profile basis since each job, and all groups have at least one associated MOSCC(s). For example, ‘O’ and ‘E’ may designate Officer and Enlisted, respectively, and a scale of 1 to 5 may indicate a leadership level. Recommendations (also referred to as connections) are indications that the first profile should connect in some way with another profile, training program, and/or job posting. For example, when a Veteran first signs-in to the System, the System automatically decodes the MOSCC(s) into keywords and makes assumptions to populate recommended job posting for the Veteran. The System may also import contact lists from other systems and recommend profile connections based on the imported list. Tracking Pointers are indications that the first profile should monitor other profiles (e.g., track a company for job openings) and/or that a tax credit may be received. A connection may be a link between a profile and other records that identify education programs, support organizations, discussion groups, mentoring groups, entrepreneur groups, and the like.

The database 220 may also include security information 230 that may be utilized by the application 110 to provide and/or generate security levels for individual records 221-229 (e.g., profiles 225, 227 and groups 228). In turn, the application may assign different groups and users different security access such that those groups and users may receive unique networking, with extra security protection. Thus, for example, military personal that have a high level of government security clearance will be able to associate and converse freely based on the security information 230. Security information 230 may include any data, processes, and mechanisms by which the application 110 protects records 221-229 and services of the application 110 from unintended or unauthorized access, change, and/or destruction.

Thus, in general, the System may perform a method, comprising: extracting at least one of an code and a characteristic from an identified profile; processing the code or the characteristic into a first dataset; automatically matching the identified member profile based on the first dataset to a plurality of content and/or groups; and generating an interface that presents at least one of the identified member profile, the first dataset, and the matched plurality of content. The System may also include a non-transitory computer readable medium storing program code executable by a processor to cause operations, comprising: extracting at least one of an code and a characteristic from an identified profile; processing the code or the characteristic into a first dataset; automatically matching the identified member profile based on the first dataset to a plurality of content and/or groups; and generating an interface that presents at least one of the identified member profile, the first dataset, and the matched plurality of content.

In another operational example where a member profile is utilized by the System for matching specific content to a profile, the System creates a member profile based on inputs received from an interface operated by a user, where the initial inputs may include a username and authorization credentials that uniquely identify that user. Once created, a user may have the option to automatically populate the user's member profile with codes and profile characteristics, such as by up loading a résumé, curriculum vitae, and/or connecting it's the user's member profile with a third party account, and/or manually inputting codes and profile characteristics that relate to their work experience. For example, if the user is a dentist in the military who does not have a resume or the like to automatically populate the user's member profile, the user may manually input the user's specific MOSCC(s) and/or Characteristics that relate to the user's military work experience as a military dentist.

If the System receives an indication of a job search based on further inputs received from the interface operated by the user, the System enables the execution of job searches based on the member profile. Inputs may include a primary indication that directly instructs the execution of a job search and an ancillary indication that permits the System to automatically research suggestions that related to the member profile. In either case, the System may access and decode the codes and profile characteristics of the member profile via databases. For example, System accesses and decodes the codes of the member profile via databases utilizing a MOSCC database that stores tables that associate MOSCC(s) to common language. Thus, if the member profile included the MOSCC of ‘47XX’, the System would pull data from a table associated with ‘47XX,’ as illustrated in Table 2. Particularly, the System may utilize any combination of data within the table row entry 240. In addition, the System may optionally determine inferences from characteristics of the member profile via heuristics.

The System matches the member profile to employers to generate results for the job search, along with matching the member profile to third parties to generate connections. To match the member profile, the System utilizes at least the combination of data extracted from the database to perform keyword matching with job descriptions, employer profiles, and the like. Similarly, the System may perform the keyword matching to connect the member profile with other third parties, such as groups, universities, entrepreneurs, mentors, mentees, and the like. The System may also auto-creates (input screen, see attached in email) a list of online groups that the user can auto-join or join individually of other users with the same or similar occupational codes. The user can un-join groups or join groups within other related codes based on career interests outside of their past work experience derived from their occupational codes entered into their user profile.

The System generates and displays user interfaces to present the results and connections. The results and connections may include job/work announcements from internal or external sources (aggregator of multiple jobs from multiple job boards); education and training offerings; employer profiles; recommended connections with profiles who could be or not be mentors, career coaches, virtual care facilitators, or support organizations. In another operation, users who represent employers, recruiters, and/or educational organizations may input postings by selecting the most important criteria for work, training, scholarships, or other positions that require an application to be submitted to be selected for limited openings. The System converts the criteria to search parameters and searches the entire member profile candidate pool (that has indicated they are available) for qualified candidates. A list of qualified candidates is displayed; the user can rate and rank the candidates; share candidate profiles with colleagues; schedule an interview with candidates; contact the candidates for additional information; hire/accept candidates; manage hired/accepted candidates; and offer ongoing digital assessments and courses to hired/accepted candidates.

In view of the above, the System saves users (e.g., Veterans and U.S. Active Military) time and money, prevents confusion, and automatically connects the users to employers, schools, general support organizations, career mentors and coaches, civilian Veteran advocates, and other peers with similar or shared work experience (e.g., as indicated by the MOSCC(s) associated with their profile).

For example, the decoding of MOSCC(s) may enable auto generation of career profiles and civilian keywords such that time saved from not filling out additional forms or having to find and add keywords manually. In practice, military personnel enter all associated MOSCC(s), Military training, performance evaluations, and recommendations into their respective profiles and the System displays a filtered content list (content pages and system profiles) based on the keyword translation associated with a combination of all entered MOSCC(s), and other data inputted. When military personnel users add their training, location, performance evaluations, awards and commendations the filtered civilian work and education list displays content that the System applies from the inputted data with customizable filters to hone in on relevant jobs, education, support organizations, and member profiles the veteran is most qualified for and interested in. Thus, the filtered list is specific to the industry, leadership level, geography, skills, and knowledge base that relate to the MOSCC(s) and other military documentation of the Veteran. The System enables a smoother, easier, faster transition from soldier/veteran to civilian by utilizing MOSCC(s) to systemically apply the skills and knowledge from the Veteran's military work experience in support of intelligently recommending civilian jobs that satisfy the Veteran's needs. Further, the MOSCC(s) decoding may enable networking through automatic group assignments, where each group includes a user with similar past work experience and/or active duty current experience across all military branches, not just within a military branch respective to that user. MOSCC(s) decoding may enable career training programs and support organization recommendations that are based on MOSCC associated with the member profile along with skill assessments, competencies, evaluations, recommendations, and mapped career interests, roles, and future goals. These recommendations, which are highly relevant content, may decrease the time spent on unnecessary searching and discovery of other user profiles, work announcements, education offers, and local support organizations.

Further, the System saves employers and recruiters time by applying multiple criteria to a candidate profile and displaying qualified and verified users that are able to provide work/labor time. Employers and recruiters can participate within targeted groups of users based on their shared military job and work experiences. For example, the employers and recruiters know their work opportunities and branding will be seen by verified military personnel that have specific shared past Military work experience. The System saves education institutions time by presenting their courses, certifications, and degree opportunities to targeted users. For example, Veterans are qualified based may utilize their GI bill eligibility and their past Military work experience to apply for and enroll in education and training offerings. Similarly, Veteran career/employment support organizations can achieve the same benefits via the System.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Further, for purposes of explanation, numerous details are set forth, such as flowcharts and system configurations, to provide an understanding of one or more embodiments. However, it is and will be apparent to one skilled in the art that these specific details are not required to practice the described.

Accordingly, it is to be understood that the above description is intended to be illustrative and not restrictive. Many embodiments and applications other than the examples provided would be apparent upon reading the above description. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The below claims specify how interactions with the Internet are manipulated to yield a desired result—a result that overrides the routine and conventional data-in data-out sequence of events ordinarily triggered by the act of searching for a job online.

What is claimed is:

1. A method of electronically connecting job searchers with third parties, the method comprising:
automatically at a server of a job search provider, in response to a user input at a web browser of a user, decoding a code of a member profile to generate a plurality of profile characteristics via a heuristic;
automatically retrieving from a data store coupled to the server a plurality of previously-established profiles;
automatically matching the member profile to one or more of the plurality of previously-established profiles to generate respective connections; and
automatically generating and presenting at least one user interface to the user, the at least one user interface indicative of a result of the matching.

2. The method according to claim 1, wherein the code includes a plurality of data bits representative of user traits selected from the group comprising previous employment, education, military starting rank, military ending rank, combat experience, deployment history, personal interests, volunteer experience, marital status, location, and age.

3. The method according to claim 1, wherein the code is a Military Occupational Specialty and Classification Code.

4. The method according to claim 1, wherein the matching includes matching a job seeker with a potential employer.

5. The method according to claim 1, wherein the decoding includes translating the code into plain language.

6. The method according to claim 1, further comprising:
automatically at the server of the job search provider, creating the member profile based on inputs received from the web browser of the user.

7. The method according to claim 6, further comprising:
automatically associating the member profile with one or more groups based on the received inputs.

8. The method according to claim 1, wherein the heuristic includes utilizing a lookup table stored in a memory.

9. The method according to claim 1, wherein the heuristic derives inferences from the profile characteristics.

10. The method according to claim 1, wherein the previously-established profiles correspond to one or more of another job candidate, an employer, an educational provider a training provider, a user group, a mentor, and a mentee.

11. A system for electronically connecting job searchers with third parties, the system comprising:
a data store at a job search provider;
a server coupled to the data store and programmed to:
automatically, in response to a user input at a web browser of a user, decode a code of a member profile to generate a plurality of profile characteristics via a heuristic;
automatically retrieve from the data store a plurality of previously-established profiles;
automatically match the member profile to one or more of the plurality of previously-established profiles to generate respective connections; and
automatically generate and present at least one user interface to the user, the at least one user interface indicative of a result of the matching.

12. The system according to claim 11, wherein the code includes a plurality of data bits representative of user traits selected from the group comprising previous employment, education, military starting rank, military ending rank, combat experience, deployment history, personal interests, volunteer experience, marital status, location, and age.

13. The system according to claim 11, wherein the code is a Military Occupational Specialty and Classification Code.

14. The system according to claim 11, wherein the matching includes matching a job seeker with a potential employer.

15. The system according to claim 11, wherein the decoding includes translating the code into plain language.

16. The system according to claim 11, wherein the server is further programmed to:
automatically at the server of the job search provider, creating the member profile based on inputs received from the web browser of the user.

17. The system according to claim 16, wherein the server is further programmed to:
automatically associating the member profile with one or more groups based on the received inputs.

18. The system according to claim 11, wherein the heuristic includes utilizing a lookup table stored in a memory.

19. The system according to claim 11, wherein the heuristic derives inferences from the profile characteristics.

20. The system according to claim 11, wherein the previously-established profiles correspond to one or more of another job candidate, an employer, an educational provider a training provider, a user group, a mentor, and a mentee
